(19) United States
(12) Patent Application Publication
(10) Pub. No.: US 2022/0132094 A1
(43) Pub. Date: Apr. 28, 2022

(54) STRUCTURED-LIGHT SCANNING SYSTEM AND METHOD

(71) Applicant: Himax Technologies Limited, Tainan City (TW)

(72) Inventors: Hsueh-Tsung Lu, Tainan City (TW); Ching-Wen Wang, Tainan City (TW); Cheng-Che Tsai, Tainan City (TW); Wu-Feng Chen, Tainan City (TW)

(21) Appl. No.: 17/354,998

(22) Filed: Jun. 22, 2021

Related U.S. Application Data
(63) Continuation-in-part of application No. 17/079,283, filed on Oct. 23, 2020.

(51) Int. Cl. H04N 13/254; H04N 5/225

(52) U.S. Cl. CPC H04N 13/254; G02B 5/20; H04N 5/2254

(57) ABSTRACT

A structured-light scanning system includes a structured-light source that generates an emitted polarized light with a predetermined pattern and a predetermined polarization, the emitted polarized light being then projected onto and reflected from a surface of an object, resulting in a reflected polarized light; a polarization modulator that adjusts polarization state of the reflected polarized light, resulting in a modulated polarized light; a polarizer that lets the modulated polarized light pass through while blocking other lights with polarizations different from the predetermined polarization, thereby outputting a filtered polarized light; and an image sensor that detects the filtered polarized light.

### CROSS-REFERENCE TO RELATED APPLICATIONS

This application is a continuation-in-part of U.S. application Ser. No. 17/079,283, filed on Oct. 23, 2020 and entitled STRUCTURED-LIGHT SCANNING SYSTEM AND METHOD, the entire contents of which are herein expressly incorporated by reference.

### BACKGROUND OF THE INVENTION

### 1. Field of the Invention

The present invention generally relates to a structured-light scanning system and method, and more particularly to a structured-light scanning system and method with a polarizer.

### 2. Description of Related Art

Structured-light scanning is the process of projecting a pattern of light onto a scene. The deformation of the pattern is captured by a camera, and then processed, for example, by triangulation, to reconstruct a three-dimensional or depth map of the objects in the scene. The structured-light scanning may, for example, be adapted to object detection for detecting objects of a certain class in digital images and videos. Specifically, the structured-light scanning may be adapted to face detection, which is a specific case of object detection, in mobile devices such as cellphones for detecting frontal human faces.

However, when the structured-light scanning is performed in the outdoors, interference caused by ambient light may greatly degrade image quality, for example, in term of signal-to-noise ratio.

A need has thus arisen to propose a novel scheme to prevent the ambient light from affecting the structured-light scanning, particularly when carried out in the outdoors.

### SUMMARY OF THE INVENTION

In view of the foregoing, it is an object of the embodiment of the present invention to provide a structured-light scanning system and method capable of being immune to interference from ambient light particularly when the structured-light scanning system is disposed outdoors or the structured-light scanning method is performed outdoors.

According to one embodiment, a structured-light scanning system includes a structured-light source, a polarizer and an image sensor. The structured-light source generates an emitted polarized light with a predetermined pattern and a predetermined polarization, the emitted polarized light being then projected onto and reflected from a surface of an object, resulting in a reflected polarized light. The polarizer lets the reflected polarized light pass through while blocking other lights with polarizations different from the predetermined polarization, thereby outputting a filtered polarized light. The image sensor detects the filtered polarized light.

According to another embodiment, a structured-light scanning system includes a structured-light source, a polarization modulator, a polarizer and an image sensor. The structured-light source generates an emitted polarized light with a predetermined pattern and a predetermined polarization, the emitted polarized light being then projected onto and reflected from a surface of an object, resulting in a reflected polarized light. The polarization modulator adjusts polarization state of the reflected polarized light, resulting in a modulated polarized light. The polarizer lets the modulated polarized light pass through while blocking other lights with polarizations different from the predetermined polarization, thereby outputting a filtered polarized light. The image sensor detects the filtered polarized light.

### BRIEF DESCRIPTION OF THE DRAWINGS

FIG. 1 shows a block diagram illustrating a structured-light scanning system according to one embodiment of the present invention;

FIG. 2 exemplifies an outdoor scenario of a structured-light scanning system composed of a structured-light source and an image sensor, but without a polarizer;

FIG. 3 exemplifies an outdoor scenario of the structured-light scanning system of FIG. 1;

FIG. 4 schematically shows a detailed block diagram of the polarizer and a camera module (that includes the image sensor) of the structured-light scanning system according to one embodiment of the present invention;

FIG. 5A and FIG. 5B schematically show detailed block diagrams of the polarizer and the camera module (that includes the image sensor) of the structured-light scanning system according to another embodiment of the present invention;

FIG. 6A and FIG. 6B schematically show detailed block diagrams of the polarizer and the camera module (that includes the image sensor) of the structured-light scanning system according to a further embodiment of the present invention;

FIG. 7 shows a block diagram illustrating a structured-light scanning system according to another embodiment of the present invention;

FIG. 8 schematically shows a birefringent material as the polarization modulator controlled by a voltage;

FIG. 9A shows a flow diagram illustrating a method of controlling the polarization modulator;

FIG. 9B shows a block diagram illustrating a system of controlling the polarization modulator;

FIG. 10 schematically shows a detailed block diagram of the polarization modulator, the polarizer and a camera module (that includes the image sensor) of the structured-light scanning system according to one embodiment of the present invention;

FIG. 11A and FIG. 11B schematically show detailed block diagrams of the polarization modulator, the polarizer and the camera module (that includes the image sensor) of the structured-light scanning system according to another embodiment of the present invention;

FIG. 12A and FIG. 12B schematically show detailed block diagrams of the polarization modulator, the polarizer and the camera module (that includes the image sensor) of the structured-light scanning system according to a further embodiment of the present invention; and

FIG. 13A to FIG. 13C schematically show detailed block diagrams of the polarization modulator, the polarizer and the camera module (that includes the image sensor) of the structured-light scanning system according to a further embodiment of the present invention.

### DETAILED DESCRIPTION OF THE INVENTION

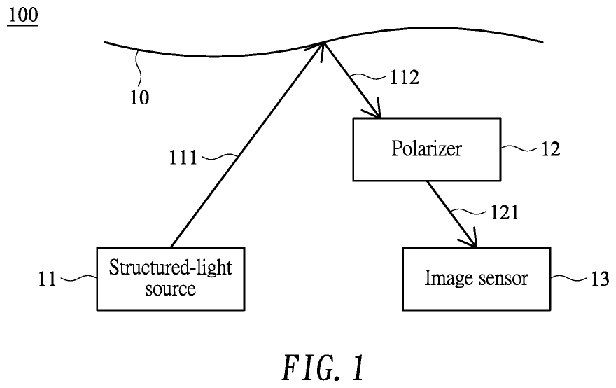

FIG. 1 shows a block diagram illustrating a structured-light scanning system 100 according to one embodiment of the present invention.

In the embodiment, the structured-light scanning system 100 may include a structured-light source 11 configured to generate an emitted polarized light 111 with a predetermined pattern and a predetermined polarization. That is, the emitted polarized light 111 is polarized in a predetermined direction. The emitted polarized light 111 may be either visible light or invisible light (such as infrared light), and the predetermined pattern may be either two-dimensional (2D) or three-dimensional (3D) pattern. The emitted polarized light 111 is then projected onto and reflected from a surface of an object 10, resulting in a reflected polarized light 112.

According to one aspect of the embodiment, the structured-light scanning system 100 of the embodiment may include a polarizer 12 configured to let the reflected polarized light 112 pass through while blocking other lights with polarizations different from the predetermined polarization of the emitted polarized light 111. Therefore, a filtered polarized light 121 is outputted from the polarizer 12.

The structured-light scanning system 100 of the embodiment may include an image sensor 13, such as a camera, configured to detect the filtered polarized light 121. It is noted that the polarizer 12 is disposed between the object 10 and the image sensor 13. The information detected by the image sensor 13 may, for example, be utilized to measure a three-dimensional shape of the object 10.

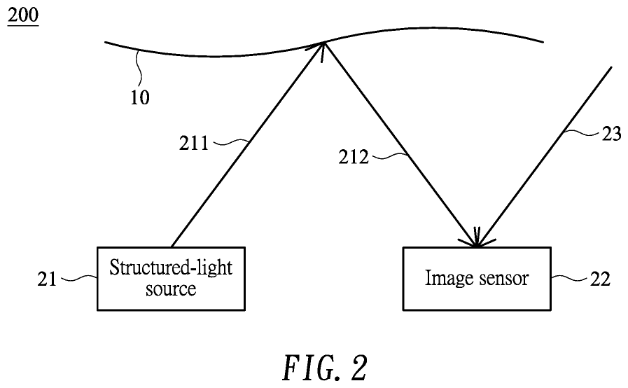

FIG. 2 exemplifies an outdoor scenario of a structured-light scanning system 200 composed of a structured-light source 21 and an image sensor 22, but without a polarizer. Specifically, the structured-light source 21 may generate an emitted light 211, which may be either polarized or non-polarized. The emitted light 211 is projected onto and reflected from a surface of an object 10, resulting in a reflected light 212. As the structured-light scanning system 200 is disposed outdoors, an ambient light 23, which is generally a non-polarized light, may irradiate the structured-light scanning system 200. The image sensor 22 may detect the ambient light 23 in addition to the reflected light 212. Accordingly, the information contained in the reflected light 212 is corrupted by the (unwanted and harmful) ambient light 23, and a true three-dimensional shape of the object 10 thus cannot be measured based on the corrupted information as detected by the image sensor 22. Therefore, the signal-to-noise ratio, which is used to characterize image quality and performance, of the structured-light scanning system 200 may be substantially reduced.

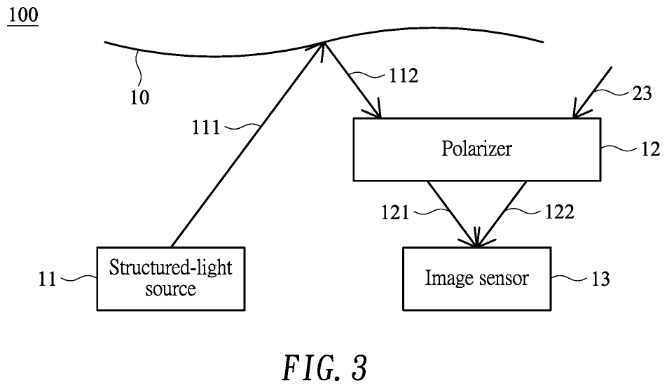

FIG. 3 exemplifies an outdoor scenario of the structured-light scanning system 100 of FIG. 1. As the structured-light scanning system 100 is disposed outside, an ambient light 23, which is generally a non-polarized light, may irradiate the structured-light scanning system 100. The ambient light 23 may be substantially blocked by the polarizer 12. Specifically, only a portion with the predetermined polarization in the ambient light 23 passes through the polarizer 12 and denoted as a filtered ambient light 122, while other portions with polarizations different from the predetermined polarization in the ambient light 23 are blocked by the polarizer 12. The image sensor 13 may then detect both the filtered polarized light 121 and the filtered ambient light 122. As the filtered ambient light 122 is substantially less than the original ambient light 23, the associated signal-to-noise ratio of the structured-light scanning system 100 in the scenario of FIG. 3 may not be significantly affected by the ambient light 23 as in the scenario of FIG. 2. Therefore, when in the outdoors, the structured-light scanning system 100 is capable of being relatively immune to interference from ambient light 23, and the three-dimensional shape of the object 10 can be measured with confidence based on the information as detected by the image sensor 13.

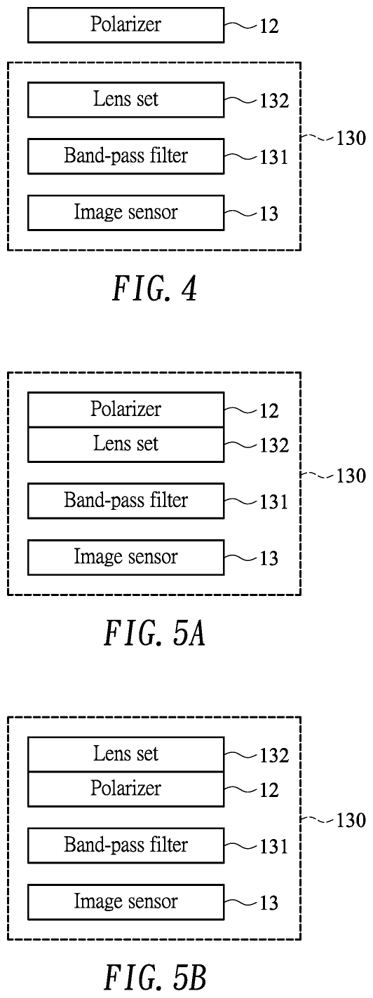

FIG. 4 schematically shows a detailed block diagram of the polarizer 12 and a camera module 130 (that includes the image sensor 13) of the structured-light scanning system 100 according to one embodiment of the present invention. Specifically, the camera module 130 may include, from bottom to top, the image sensor 13, a band-pass filter 131 and a lens set 132. The lens set 132 may include at least one optical lens, and the band-pass filter 131 is configured to pass light with frequencies within a certain range and to reject (or attenuate) light with frequencies outside said range. In the embodiment, the polarizer 12, as a plug-in device, is disposed outside the camera module 130.

FIG. 5A and FIG. 5B schematically show detailed block diagrams of the polarizer 12 and the camera module 130 (that includes the image sensor 13) of the structured-light scanning system 100 according to another embodiment of the present invention. In the embodiment as illustrated in FIG. 5A, the polarizer 12 is disposed inside the camera module 130, and is coated on a top surface of the lens set 132 facing the object 10 (or opposite the image sensor 13). In the embodiment as illustrated in FIG. 5B, the polarizer 12 is disposed inside the camera module 130, and is coated on a bottom surface of the lens set 132 facing the image sensor 13.

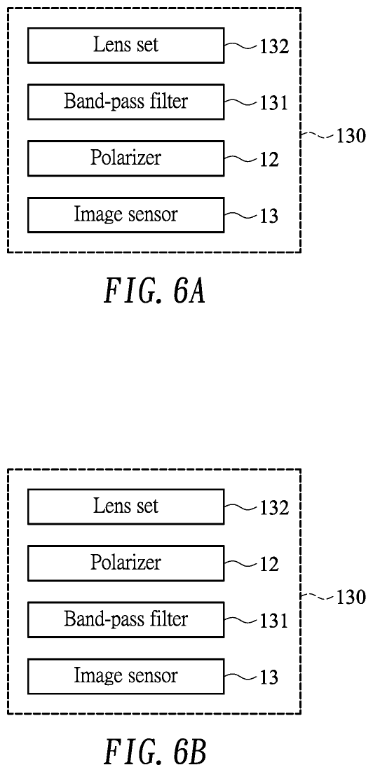

FIG. 6A and FIG. 6B schematically show detailed block diagrams of the polarizer 12 and the camera module 130 (that includes the image sensor 13) of the structured-light scanning system 100 according to a further embodiment of the present invention. In the embodiment as illustrated in FIG. 6A, the polarizer 12 is disposed inside the camera module 130 and is disposed between (and distanced from) the image sensor 13 and the band-pass filter 131. In the embodiment as illustrated in FIG. 6B, the polarizer 12 is disposed inside the camera module 130 and is disposed between (and distanced from) the band-pass filter 131 and the lens set 132.

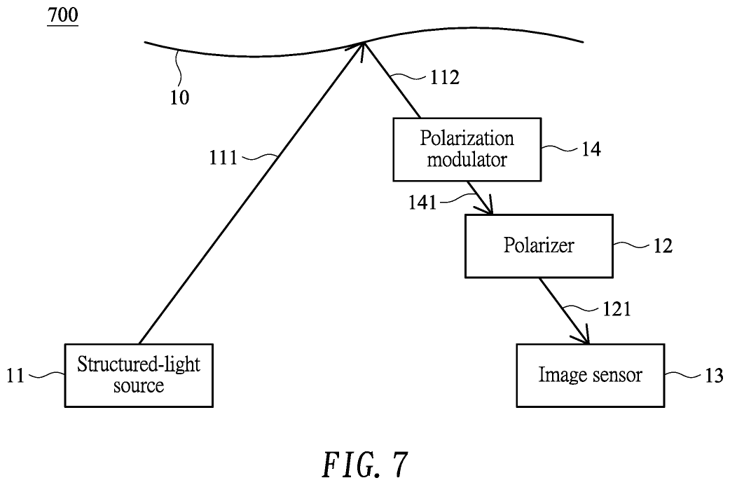

FIG. 7 shows a block diagram illustrating a structured-light scanning system 700 according to another embodiment of the present invention.

In the embodiment, the structured-light scanning system 700 may include a structured-light source 11 configured to generate an emitted polarized light 111 with a predetermined pattern and a predetermined polarization. That is, the emitted polarized light 111 is polarized in a predetermined direction. The emitted polarized light 111 may be either visible light or invisible light (such as infrared light), and the predetermined pattern may be either two-dimensional (2D) or three-dimensional (3D) pattern. The emitted polarized light 111 is then projected onto and reflected from a surface of an object 10, resulting in a reflected polarized light 112.

According to one aspect of the embodiment, the structured-light scanning system 700 may include a polarization modulator 14 configured to adjust polarization state of the reflected polarized light 112, resulting in a modulated polarized light 141. Specifically, the polarization modulator 14 may adjust the polarization state such that the polarization of the modulated polarized light 141 is parallel with the transmission axis of the band-pass filter 131 irrespective of reflection characteristics (e.g., material property and shape) of the surface of the object 10, thereby maximizing signal transmittance and signal-to-noise ratio.

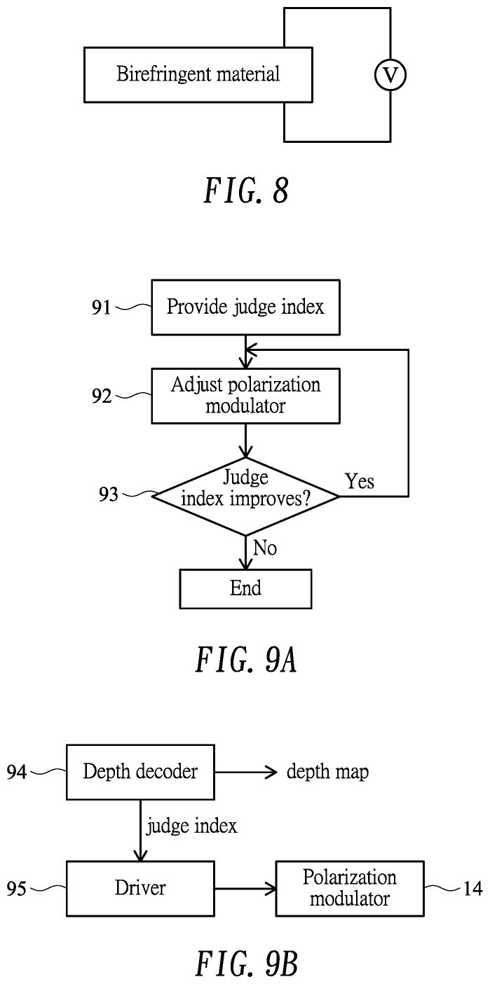

The polarization modulator 14 of the embodiment may include a birefringent (or birefractive) material or an electro-optical material (such as liquid crystal). FIG. 8 schematically shows a birefringent material as the polarization modulator 14 controlled by a voltage. Accordingly, optical axis or phase delay may be adjusted to achieve polarization modulation.

FIG. 9A shows a flow diagram illustrating a method of controlling the polarization modulator 14, and FIG. 9B shows a block diagram illustrating a system of controlling the polarization modulator 14. Specifically, in step 91, a judge index (such as depth decode rate, signal-to-noise ratio or average brightness value) is provided by a depth decoder 94. In step 92, the polarization modulator 14 is adjusted by a driver 95 according to the judge index. Next, in step 93, it determines whether the judge index improves. The adjustment of the polarization modulator 14 is repeatedly performed until the judge index no longer improves.

In the embodiment, the structured-light scanning system 700 of the embodiment may include a polarizer 12 configured to let the modulated polarized light 141 pass through while blocking other lights with polarizations different from the predetermined polarization of the emitted polarized light 111. Therefore, a filtered polarized light 121 is outputted from the polarizer 12.

The structured-light scanning system 700 of the embodiment may include an image sensor 13, such as a camera, configured to detect the filtered polarized light 121. It is noted that the polarization modulator 14 is disposed between the object 10 and the polarizer 12, and the polarizer 12 is disposed between the polarization modulator 14 and the image sensor 13. The information detected by the image sensor 13 may, for example, be utilized to measure a three-dimensional shape of the object 10

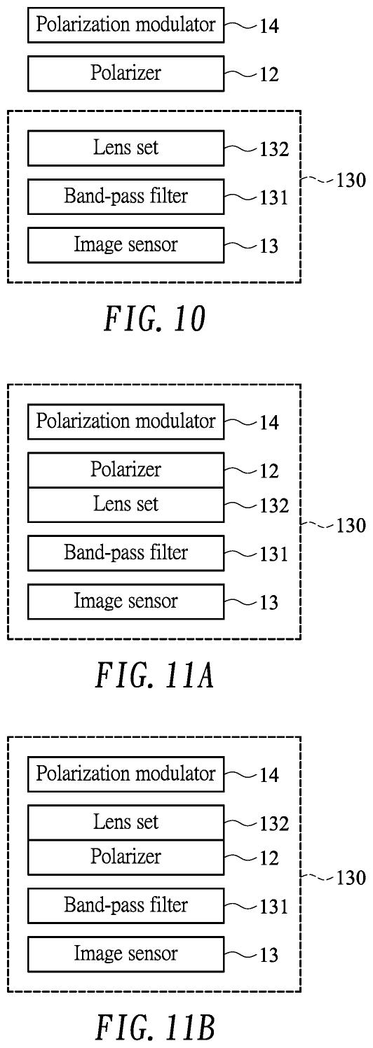

FIG. 10 schematically shows a detailed block diagram of the polarization modulator 14, the polarizer 12 and a camera module 130 (that includes the image sensor 13) of the structured-light scanning system 700 according to one embodiment of the present invention. Specifically, the camera module 130 may include, from bottom to top, the image sensor 13, a band-pass filter 131 and a lens set 132. The lens set 132 may include at least one optical lens, and the band-pass filter 131 is configured to pass light with frequencies within a certain range and to reject (or attenuate) light with frequencies outside said range. In the embodiment, the polarizer 12 and the polarization modulator 14, as plug-in devices, are disposed outside the camera module 130.

FIG. 11A and FIG. 11B schematically show detailed block diagrams of the polarization modulator 14, the polarizer 12 and the camera module 130 (that includes the image sensor 13) of the structured-light scanning system 700 according to another embodiment of the present invention. In the embodiment as illustrated in FIG. 11A, the polarization modulator 14 is disposed inside the camera module 130. The polarizer 12 is disposed inside the camera module 130, and is coated on a top surface of the lens set 132 facing the object 10 (or opposite the image sensor 13). In the embodiment as illustrated in FIG. 11B, the polarization modulator 14 is disposed inside the camera module 130 and above the lens set 132. The polarizer 12 is disposed inside the camera module 130, and is coated on a bottom surface of the lens set 132 facing the image sensor 13.

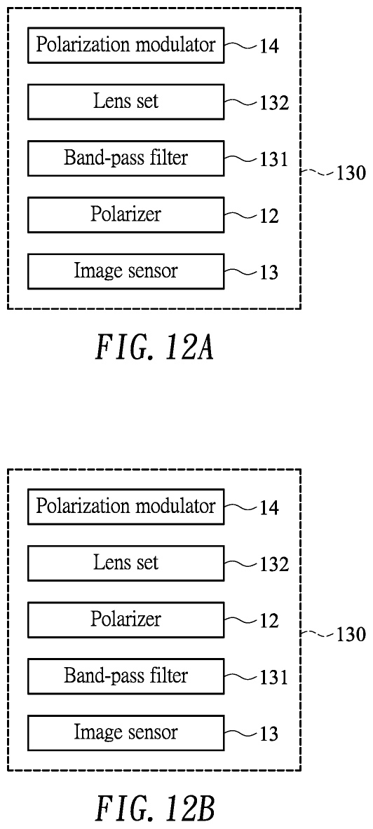

FIG. 12A and FIG. 12B schematically show detailed block diagrams of the polarization modulator 14, the polarizer 12 and the camera module 130 (that includes the image sensor 13) of the structured-light scanning system 700 according to a further embodiment of the present invention. In the embodiment as illustrated in FIG. 12A, the polarization modulator 14 is disposed inside the camera module 130 and above the lens set 132. The polarizer 12 is disposed inside the camera module 130 and is disposed between (and distanced from) the image sensor 13 and the band-pass filter 131. In the embodiment as illustrated in FIG. 12B, the polarization modulator 14 is disposed inside the camera module 130 and above the lens set 132. The polarizer 12 is disposed inside the camera module 130 and is disposed between (and distanced from) the band-pass filter 131 and the lens set 132.

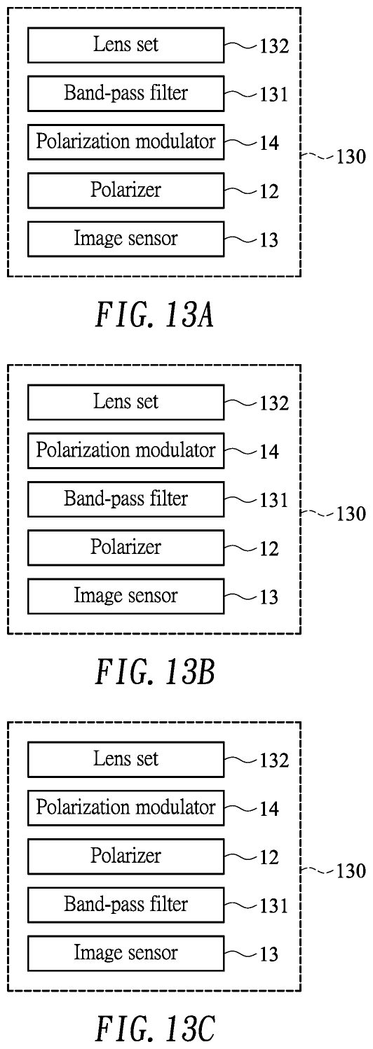

FIG. 13A to FIG. 13C schematically show detailed block diagrams of the polarization modulator 14, the polarizer 12 and the camera module 130 (that includes the image sensor 13) of the structured-light scanning system 700 according to a further embodiment of the present invention. The embodiment of FIG. 13A is similar to the embodiment of FIG. 12A except that the polarization modulator 14 is instead disposed between the polarizer 12 and the band-pass filter 131. The embodiment of FIG. 13B is similar to the embodiment of FIG. 12A except that the polarization modulator 14 is instead disposed between the band-pass filter 131 and the lens set 132. The embodiment of FIG. 13C is similar to the embodiment of FIG. 12B except that the polarization modulator 14 is instead disposed between the polarizer 12 and the lens set 132.

Although specific embodiments have been illustrated and described, it will be appreciated by those skilled in the art that various modifications may be made without departing from the scope of the present invention, which is intended to be limited solely by the appended claims.

What is claimed is:

1. A structured-light scanning system, comprising:
a structured-light source that generates an emitted polarized light with a predetermined pattern and a predetermined polarization, the emitted polarized light being then projected onto and reflected from a surface of an object, resulting in a reflected polarized light;
a polarization modulator that adjusts polarization state of the reflected polarized light, resulting in a modulated polarized light;
a polarizer that lets the modulated polarized light pass through while blocking other lights with polarizations different from the predetermined polarization, thereby outputting a filtered polarized light; and
an image sensor that detects the filtered polarized light.

2. The system of claim 1, further comprising:
a band-pass filter disposed over the image sensor, the band-pass filter passing light with frequencies within a specific range and attenuating light with frequencies outside said range; and
a lens set disposed over the band-pass filter, the lens set including at least one optical lens;
wherein the image sensor, the band-pass filter and the lens set constitute a camera module.

3. The system of claim 2, wherein the polarization modulator and the polarizer are disposed outside the camera module.

4. The system of claim 2, wherein the polarization modulator is disposed inside the camera module, and the polarizer is coated on a top surface of the lens set, the top surface being opposite the image sensor.

5. The system of claim 2, wherein the polarization modulator is disposed inside the camera module and above the lens set, and the polarizer is coated on a bottom surface of the lens set, the bottom surface facing the image sensor.

6. The system of claim 2, wherein the polarization modulator is disposed inside the camera module and above the lens set, and the polarizer is disposed between the image sensor and the band-pass filter.

7. The system of claim 2, wherein the polarization modulator is disposed inside the camera module and above the lens set, and the polarizer is disposed between the band-pass filter and the lens set.

8. The system of claim 2, wherein the polarization modulator is disposed between the polarizer and the band-pass filter, and the polarizer is disposed between the image sensor and the polarization modulator.

9. The system of claim 2, wherein the polarization modulator is disposed between the band-pass filter and the lens set, and the polarizer is disposed between the image sensor and the band-pass filter.

10. The system of claim 2, wherein the polarization modulator is disposed between the polarizer and the lens set, and the polarizer is disposed between the band-pass filter and the polarization modulator.

11. A structured-light scanning method, comprising:
generating an emitted polarized light with a predetermined pattern and a predetermined polarization, the emitted polarized light being then projected onto and reflected from a surface of an object, resulting in a reflected polarized light;
adjusting polarization state of the reflected polarized light, resulting in a modulated polarized light;
letting the modulated polarized light pass through while blocking other lights with polarizations different from the predetermined polarization, thereby outputting a filtered polarized light; and
detecting the filtered polarized light.

12. The method of claim 11, wherein the modulated polarized light is outputted by a polarization modulator, the filtered polarized light is outputted by a polarizer and is detected by an image sensor, the method further comprising:
providing a band-pass filter disposed over the image sensor, the band-pass filter passing light with frequencies within a specific range and attenuating light with frequencies outside said range; and
providing a lens set disposed over the band-pass filter, the lens set including at least one optical lens;
wherein the image sensor, the band-pass filter and the lens set constitute a camera module.

13. The method of claim 12, wherein the polarization modulator and the polarizer are disposed outside the camera module.

14. The method of claim 12, wherein the polarization modulator is disposed inside the camera module, and the polarizer is coated on a top surface of the lens set, the top surface being opposite the image sensor.

15. The method of claim 12, wherein the polarization modulator is disposed inside the camera module and above the lens set, and the polarizer is coated on a bottom surface of the lens set, the bottom surface facing the image sensor.

16. The method of claim 12, wherein the polarization modulator is disposed inside the camera module and above the lens set, and the polarizer is disposed between the image sensor and the band-pass filter.

17. The method of claim 12, wherein the polarization modulator is disposed inside the camera module and above the lens set, and the polarizer is disposed between the band-pass filter and the lens set.

18. The method of claim 12, wherein the polarization modulator is disposed between the polarizer and the band-pass filter, and the polarizer is disposed between the image sensor and the polarization modulator.

19. The method of claim 12, wherein the polarization modulator is disposed between the band-pass filter and the lens set, and the polarizer is disposed between the image sensor and the band-pass filter.

20. The method of claim 12, wherein the polarization modulator is disposed between the polarizer and the lens set, and the polarizer is disposed between the band-pass filter and the polarization modulator.
